(19) United States
(12) Patent Application Publication
(10) Pub. No.: US 2011/0302844 A1
(43) Pub. Date: Dec. 15, 2011

(54) PLATFORM SAFETY GATE

(75) Inventor: Douglas Morey, Clarendon Hills, IL (US)

(73) Assignee: WESTMONT ENGINEERING COMPANY, Broadview, IL (US)

(21) Appl. No.: 13/151,396

(22) Filed: Jun. 2, 2011

Related U.S. Application Data
(60) Provisional application No. 61/352,975, filed on Jun. 9, 2010.

(51) Int. Cl. E05D 15/16

(52) U.S. Cl. 49/360

(57) ABSTRACT

A safety gate (10) comprises an isolation gate (100) having a rail (28) extending the width of an opening in a perimeter handrail, and side rails (14a, 14b and 16a, 16b) extending along opposite sides of a pallet loading area. The isolation gate prevents access to the area when lowered. A perimeter gate (200) has a frame (28) installed between two posts (22a, 22b). One end of a rope (R) attaches to this frame and the other end attaches to side rails on the sides of the isolation gate. When the perimeter gate is lowered to protect workers on the platform, the isolation gate is raised. When a pallet is to be placed on the platform, lowering the isolation gate raises the perimeter gate. The lowered isolation gate protects workers from falling off the platform. When the pallet is in place, the perimeter gate is lowered back down.

### CROSS-REFERENCE TO RELATED APPLICATIONS

U.S. provisional patent application 61/352,975 filed Jun. 9, 2010.

### STATEMENT REGARDING FEDERALLY SPONSORED RESEARCH

Not Applicable.

### BACKGROUND OF THE INVENTION

This invention relates to safety gates such as those used on platforms or docks where pallets of material are brought, so to protect a worker handling the pallet and its contents.

In some manufacturing facilities, materials used in a manufacturing process are stored on a pallet or skid from which the material is dispensed from an upper level of the facility to equipment located on a lower level of the facility. For example, in a blending/mixing operation, an open topped blender mixes various ingredients as part of a manufacturing operation. The blender sits, for example, on the floor of the facility. Materials to be mixed in the blender are dumped or poured into the blender from a level above the top of the blender. These materials are stored or warehoused on a pallet until ready for use. The pallet is then moved onto the platform from which a worker dispenses the material into the blender.

It will be appreciated that this operation is potentially dangerous and that a safety gate, guard rail, or the like must be in place to protect the worker throughout the unloading process. The process requires that the platform edge be blocked or barricaded when pallets are not being loaded onto or removed from the platform to prevent people from falling off the edge of the platform. The barricade must then be moved out of the way to allow the pallet to be moved onto or off of the platform. Movement of the pallet is typically performed using a fork lift. During lifting of the pallet or skid onto the platform, the worker must still be protected from falling off the edge of the platform. Then, during unloading of the skid, the safety gate or guard needs to afford a worker the ability to easily offload or work with the contents of the pallet, while the worker (and others) is protected from harm.

Various safety mechanisms are known for enabling the process described above. See, for example, U.S. patents

| | | |
|---|---|---|
| 7,017,643 | 6,138,812 | 5,216,782 |
| 6,837,296 | 5,709,050 | 4,938,095 |
| 6,412,220 | 5,701,701 | 4,422,264 |
| 6,212,826 | 5,546,703 | |

All of the apparatus described in these patents, as well as other apparatus currently in use have drawbacks. In particular, the apparatus does not allow a worker ready accessibility to the sides of the pallet so the worker can work efficiently to unload its contents. With the present invention, the pallet is fully accessible when the safety structure is in a closed perimeter railing position and fall protection is not compromised when the safety structure is in the isolation railing position and pallets are loaded onto or removed from the platform.

### BRIEF SUMMARY OF THE INVENTION

The present invention is directed to apparatus comprising two gates, an isolation gate and a perimeter gate which, together, protect a worker from falling from a platform from which pallets are loaded or unloaded. The perimeter gate is similar to a perimeter hand railing having horizontal barricade rails or members and a kick plate. The isolation gate is a three-sided structure which isolates and partitions off a pallet loading area where a skid is to be loaded or off-loaded by a fork lift. The two gates are operated in unison using a cable/pulley mechanism. This allows the two gates to counterbalance each other so that when the isolation gate is raised the perimeter gate is lowered; and, when the isolation gate is lowered the perimeter gate is raised.

Let it be assumed that an opening along the perimeter handrailing is present. Through this opening, pallets are loaded onto or off of the platform. The isolation gate has a front rail extending across the width of the opening in the perimeter handrailing where the apparatus is installed and each end of the front rail is connected to a post. A pair of spaced apart, parallel side rails extends along opposite sides of the apparatus and, when the isolation gate is lowered, prevents access to the pallet loading area from its sides.

A pair of posts is installed on opposite sides of the opening in the perimeter handrailing, at the outer end of the platform. Brackets extend inwardly from each of these posts and the other end of each side rail is rotatably attached to one of the brackets.

The perimeter gate comprises a frame which is vertically movable installed between the pair of permanently mounted posts. A lower portion of the frame comprises a “kick” plate which, when the perimeter gate is lowered, prevents material on the pallet from inadvertently toppling over the side of the platform.

A pulley is mounted atop at least one, and preferably, both of this second pair of posts and is attached to a rod spanning the posts. A cable or rope has one end secured to the perimeter gate frame, passes around the pulley, and has its other end connected to one of the side rails of the isolation gate for movement of the frame to raise and lower the front rail and side rails.

Whenever a pallet is not being loaded onto or off of the platform, the perimeter gate is lowered to prevent workers from falling from the platform. When a pallet is to be placed on the platform, a worker pulls on the frame of the isolation gate to lower it into place for protection from the loading area. This action lifts the horizontal barricade rails and kick plate of the perimeter gate up and away from the platform so the pallet can be set in place. When the pallet is in place, the worker raises the three-sided isolation gate which lowers the horizontal barricade rails and kick plate of the perimeter gate back into place, blocking fork lift access to the platform.

The apparatus is relatively low in cost and easy to install and operate. Importantly, when the isolation gate is raised, no portion of it remains in touch with the platform giving a worker ready access to the pallet and making it easier to unload.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a plan view of the safety gate apparatus with an isolation gate in its lowered position and a perimeter gate in its raised position;

FIG. 2 is a side view of the safety gate apparatus with the isolation gate in its lowered position and the perimeter gate in its raised position;

FIG. 3 is a plan view of the safety gate apparatus with the isolation gate in its raised position and the perimeter gate in its lowered position;

FIG. 4 is a side view of the safety gate apparatus with the isolation gate in its raised position and the perimeter gate in its lowered position;

FIG. 5 is an isometric view of the apparatus with the isolation gate in its lowered position and the perimeter gate in its raised position;

FIG. 6 is a front elevation view of the apparatus with the isolation gate in its raised position and the perimeter gate in its lowered position; and,

FIG. 7 is a front elevation view of the apparatus with the perimeter gate in its raised position and the isolation gate is not shown.

Corresponding reference characters indicate corresponding parts throughout the several views of the drawings.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

A safety gate apparatus 10 of the present invention comprises a safety gate or guard rail for protecting workers working in a pallet loading area. As shown in the drawings, the pallet P is loaded with materials M which can be any one of a variety of commodities. The pallet is raised onto a floor F of a platform adjacent an edge E of the platform. A worker then typically unloads the material into the top of processing or blending equipment or stores the material on the platform. The type of work performed once the pallet is in place does not matter in this discussion. It is only assumed that the worker needs full access to the pallet once it is properly loaded onto the platform.

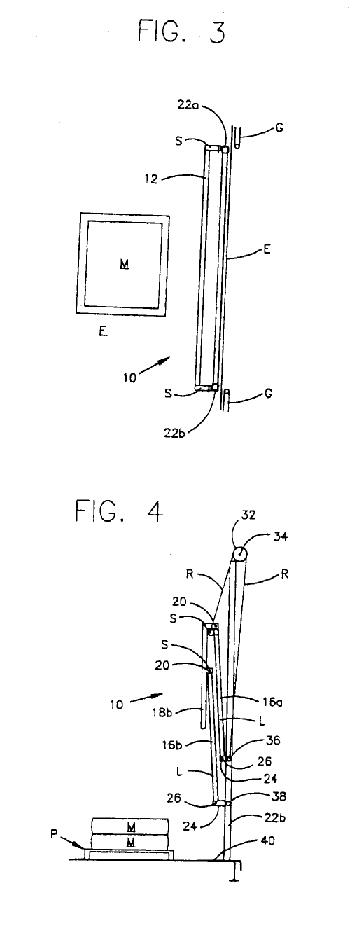

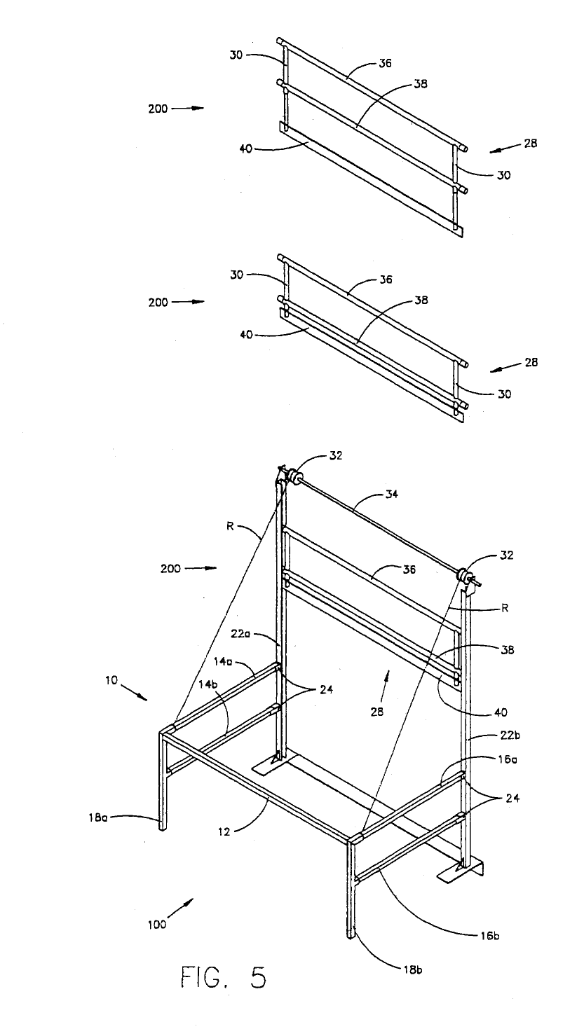

Referring to FIGS. 1, 2, and 5, when preparing to raise a pallet onto the platform, an isolation gate 100 of apparatus 10 is in its lowered position so to block the front and sides of the pallet loading area and prevent access to it while a perimeter gate 200 of the apparatus is in its raised position. Referring to FIGS. 3, 4, and 6, when a pallet is in place on the platform floor F, isolation gate 100 is raised so a worker can access the pallet, while perimeter gate 200 is lowered to prevent the worker from falling over the edge E of the platform.

Isolation gate 100 first includes a front rail 12 extending the width of the opening in the perimeter handrailing. When the isolation gate is lowered, rail 12 prevents anyone from accessing the pallet loading area from the front of it.

Next, the isolation gate 100 has two pair of vertically spaced apart side rails 14a, 14b and 16a, 16b. One pair of side rails 14a, 14b extends along one side of the pallet loading area and the other pair 16a, 16b extends along the opposite side of the pallet loading area. These side rails prevent one from accessing the pallet loading area from either side when the isolation gate is lowered.

Posts 18a, 18b are positioned at the front end of isolation gate 100, on opposite sides of the gate. One end of the front rail 12 is attached to vertical post 18a, with the other end of the front rail attached to vertical post 18b. The height of posts 18a and 18b may vary upon the particular installation, but their height is, for this example, 3′6″.

Next, the outer end of each side rail 14a, 14b is rotatably attached to post 18a, while the outer end of each of rail 16a, 16b is rotatably attached to post 18b. As particularly shown in FIG. 4, each side rail comprises two sections L and S. Section L is the longer of the two sections and S is the shorter of them. Sections L and S are hinged together, as indicated at hinge point 20 so when the isolation gate is raised, the side rails collapse tightly against posts 18a, 18b, resulting in a narrow profile with little platform interference.

A platform guardrail G extends along the edge of the perimeter of the platform floor F. An opening in the guardrail G (see, particularly, FIG. 3) allows a forklift access to the platform floor F for loading and unloading of pallets. A pair of permanently mounted posts 22a, 22b are installed adjacent the ends of the guardrail opening. The isolation gate and perimeter gate are raised and lowered relative to these stationary posts 22a, 22b. A pair of brackets 24 attach the side rails 14a, 14b, 16a, 16b of the isolation gate to the posts 22a, 22b. These brackets act as hinges and allow the side rails to pivot about the hinge point 26.

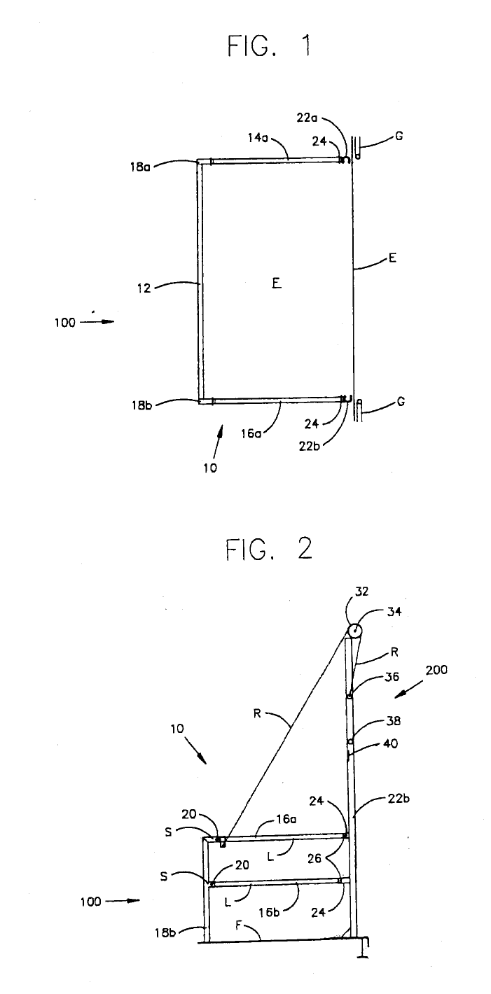

Posts 22a, 22b are generally U-shaped or have a groove or slot with the open portion of the U facing the opening in the guardrail G. A perimeter gate 200 comprises a frame assembly indicated generally 28 in the drawings which is generally rectangular in shape. Vertical sections 30 of the frame 28 are received in slots (not shown) extending along the inside of the posts 22a, 22b. This prohibits lateral movement of the frame and allows the perimeter gate to smoothly be raised or lowered. Pulleys 32 are mounted on the opposite ends of a rod 34 which extends between posts 22a, 22b. A rope or cable R passes around each pulley. One end of the rope is secured to frame 28 and the other end of the rope or cable is attached to one of the respective top side rails 14a, 16a. This end of the rope or cable is attached to the rail inwardly of the connection between sections S and L of the rail as shown in FIG. 2.

Perimeter gate frame 28 includes a top horizontal bar 36, a middle bar 38 and a lower plate 40 which is also referred to as a kick plate.

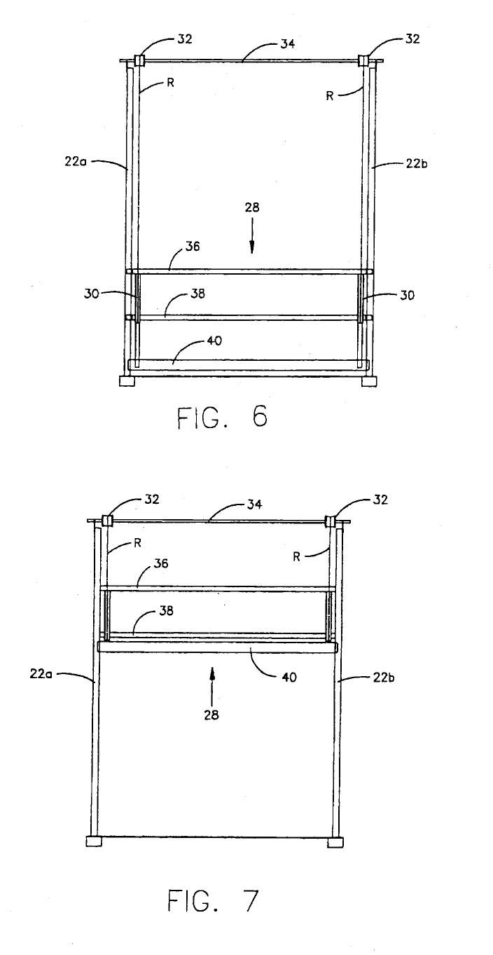

When pallets are not being placed onto or removed from the platform, the perimeter gate 200 of apparatus 10 is lowered. As previously discussed, in this lowered position, the perimeter gate acts as a guardrail preventing workers from falling off of the platform. When a pallet P is about to be placed on the platform, a worker standing to the side of the apparatus pulls downwardly on one of the members of isolation gate 100 such as post 18a, 18b. This action pulls the one end of the ropes or cables R downward with the other end of the ropes now lifting the top horizontal bar 36, middle bar 38, and lower plate 40 of perimeter gate 200 up and away from the platform as shown in FIGS. 1, 2, 5, and 7. Pallet P can be now set in place. Once the pallet is in place, the worker lifts the isolation gate rails out of the way, lowering the perimeter gate frame 28. A worker can now access the pallet to unload the material M on it.

The perimeter gate 20 can be built as a solid frame with the top horizontal bar 36, middle bar 38, lower plate 40, and vertical sections 30 permanently attached together. Alternately, these components can be designed to move relative to each other. For example, vertical sections 30 can be constructed to telescope. As the isolation gate is lowered, the lower plate is raised to join the middle bar. Both the lower plate and middle bar are raised to join the top horizontal bar. Finally, all three pieces of the perimeter gate are fully raised. Telescoping the perimeter gate frame 28 increases the clearance for loading a pallet through posts 22a and 22b. All, some, or none of the vertical sections 30 may telescope based on project cost and clearance requirements.

As shown in FIG. 4, as upper side rail 16a (and not shown 14a) of isolation gate 100 are lifted upwardly, the side rails hinge about the hinge point 26 on the post brackets 24. Because the upper and lower side rails on each side of the isolation gate are connected to the posts 18a, 18b, the lower side rails 14b, 16b are also lifted, as is front rail 12 which is also connected to the posts. Further, as the side rails are raised, their sections S and L hinge about the respective hinge points 20 so, as shown in FIG. 4, posts 18a, 18b hang generally vertically. This not only makes the raised position of the isolation gate more compact, but also keeps these gate components from interfering with the unloading activity because they are out of the way of the worker.

Importantly, it is a feature of the apparatus that when the isolation gate is raised, all the components of the isolation gate are fully off the floor F, again, making it easier to work around pallet P.

When the pallet is to be removed, the worker raises frame 28 of perimeter gate 200 by pulling on isolation gate post 18a, 18b. It is important to note that the worker must stand outside of the pallet loading area to be properly protected. Also, he does not raise frame 28 by directly lifting the perimeter gate frame. Doing so would position the worker unacceptably close to the edge E of the platform in an unprotected position. Standing outside of the pallet loading area and pulling on post 18a, 18b pulls the ropes or cables R attached to the perimeter gate frame 28 and allows the side rails and front rail of isolation gate 100 to be lowered back into place, blocking access to the pallet loading area.

In view of the above, it will be seen that the several objects and advantages of the present disclosure have been achieved and other advantageous results have been obtained.

Having thus described the invention, what is claimed and desired to be secured by Letters Patent is:

1. Safety gate apparatus for controlling access to a pallet loading area of a platform comprising:
an isolation gate including a front rail extending the width of the opening in the platform handrailing through which a pallet is loaded or unloaded, at least one side rail extending along opposite sides of the pallet loading area, the front rail and respective side rails, when the gate is lowered, blocking access to the pallet loading area, and a first pair of posts to which opposite ends of the front rail are attached and to which one end of each of the side rails is attached;
a second pair of posts installed on opposite sides of the guardrail opening;
a perimeter gate with a moveable frame; and
a pulley system to raise and lower the isolation gate while simultaneously lowering and raising the perimeter gate thereby allowing access to the platform when a pallet is in place, prohibiting access to the pallet loading area when the pallet is being loaded or unloaded onto the platform, thereby insuring worker safety;

2. The apparatus of claim 1 in which a pulley mounted atop each of the second pair of posts and to a rod located between the posts and a rope or cable passing around each pulley, one end of each rope or cable being attached to one of the side rails of the isolation gate with the other end of the rope or cable secured to the perimeter gate.

3. The apparatus of claim 1 further including brackets attached to each post of the second pair of posts with the other end of each side rail being hingedly attached to a respective one of the brackets.

4. The apparatus of claim 1 in which each side rail of the isolation gate comprises two sections, a longer section and a shorter section, each end of the front rail being connected to one end of one of the shorter side rail sections, and the two side rail sections being hinged together so that when the isolation gate is raised, the longer side rail sections will hang generally vertically.

5. The apparatus of claim 1 which, when the isolation gate is in its raised position, is suspended above the platform and has no part remaining in contact with the platform.

6. The apparatus of claim 4 further including two side rails on each side of the isolation gate, both sides rails being connected to the respective posts and having two sections hinged together.

7. The apparatus of claim 1 in which the perimeter gate frame includes a top bar, a middle bar and a lower plate, attached by potentially telescoping vertical sections; and

8. The apparatus of claim 7 in which the lower plate is a kick plate which, when the perimeter gate is lowered prevents material from falling off of the platform.
